(19) United States
(12) Patent Application Publication
(10) Pub. No.: US 2024/0420404 A1
(43) Pub. Date: Dec. 19, 2024

(54) GENERATING ENHANCED VIDEO MESSAGES FROM CAPTURED SPEECH

(71) Applicant: Microsoft Technology Licensing, LLC, Redmond, WA (US)

(72) Inventors: Mustafa KASAP, Kenmore, WA (US); Jason HOGG, Kirkland, WA (US)

(21) Appl. No.: 18/335,771

(22) Filed: Jun. 15, 2023

(51) Int. Cl. G06T 13/80; G06F 16/34; G10L 15/18; G10L 15/26; G10L 25/63

(52) U.S. Cl. CPC G06T 13/80; G06F 16/345; G10L 15/1815; G10L 15/26; G10L 25/63

(57) ABSTRACT

This disclosure describes a speech-to-video system that automatically generates enhanced short-form videos from speech. For example, the speech-to-video system utilizes different speech processing models to analyze speech in audio input and determine contextual features. Additionally, the speech-to-video system utilizes various video generation models to create enhanced short-form videos using text summaries, audio contexts, user information, video parameter inputs, and/or other user contexts. In some cases, the speech-to-video system leverages components of a mobile core network to efficiently generate and deliver these features to mobile devices.

### BACKGROUND

Modern mobile networks continue to advance in both hardware and software to provide faster data capabilities and enhanced network performance. Notably, fifth-generation (5G) mobile core networks provide network functions that offer high availability and high-speed communications. These advancements, combined with the ever-growing demand for video content, are transforming the landscape of media sharing. Additionally, as video sharing has become increasingly popular, recent advancements in machine-learning models have provided innovative approaches to video content generation. Despite these advancements, additional opportunities exist for leveraging the power of machine-learning algorithms along with innovations in mobile networks to more efficiently and flexibly generate video content automatically.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an overview example of implementing a speech-to-video system that automatically generates enhanced short-form videos from audio input of a user's speech.

FIG. 2A illustrates an example block diagram of a system environment where a speech-to-video system is implemented.

FIG. 2B illustrates an example core network that implements a speech-to-video system.

FIG. 3 illustrates a block diagram of an example pipeline for generating a short-form video utilizing the speech-to-video system.

FIG. 4 illustrates a sequence flow diagram of the speech-to-video system generating a short-form video for a first user device to send to other user devices.

FIG. 5 illustrates a sequence flow diagram of the speech-to-video system generating a short-form video for a user device that receives audio input from another user device.

FIG. 6 illustrates an example graphical user interface for a user to request a short-form video to be generated.

FIG. 7 illustrates an example block diagram of speech-processing models.

FIG. 8 illustrates an example block diagram of generative language models.

FIG. 9 illustrates an example block diagram of speech-to-video models.

FIGS. 10-11 illustrate an example series of acts in a computer-implemented method for generating short-form video content from audio input.

FIG. 12 illustrates components included within an example computer system.

### DETAILED DESCRIPTION

The present disclosure describes a speech-to-video system that accurately and flexibly generates enhanced short-form videos automatically from speech. For instance, the speech-to-video system utilizes various speech processing models to analyze speech within audio input and determine various contextual features. In addition, the speech-to-video system utilizes generative language models to generate context-based text summaries of the audio input. Further, the speech-to-video system utilizes various video generation models to generate enhanced short-form videos using text summaries, audio contexts, user information, video parameter inputs, and/or other user contexts. In various instances, the speech-to-video system utilizes components of a mobile core network to quickly generate and provide these features to users of mobile devices.

To illustrate, in one or more implementations, the speech-to-video system receives a video generation request from a user client device that includes audio input of a user speaking. In response, the speech-to-video system utilizes one or more speech-processing machine-learning models to generate a text transcript and audio context of the audio input. Additionally, the speech-to-video system generates a text summary of the audio input using a generative language model based on the text transcript and, in some instances, the audio context. The speech-to-video system then utilizes a speech-to-video machine-learning model to generate a short-form video based on the text summary and the audio context. Further, the speech-to-video system provides the short-form video to the user client device and enables the short-form video to be shared with other recipient user devices.

In another implementation, the speech-to-video system receives a video generation request from a user client device that includes audio input with speech from another user (e.g., a voicemail message). In response, the speech-to-video system generates a text transcript, audio context, and text summary of the audio input utilizing various models. Using the summary and the audio context, the speech-to-video system then generates a short-form video utilizing a speech-to-video machine-learning model. Additionally, the speech-to-video system provides the short-form video to the client device of the user for viewing.

As described in this document, the speech-to-video system delivers several significant technical benefits in terms of computing efficiency and flexibility compared to existing systems. Moreover, the speech-to-video system provides several practical applications that address problems related to generating short-form videos.

As noted above, the speech-to-video system provides a framework and pipeline for automatically generating enhanced short-form videos from the speech of a user. For example, the speech-to-video system leverages a pipeline of machine-learning models to efficiently generate short-form videos. Additionally, the speech-to-video system utilizes various models along the pipeline to increase accuracy and enhance the quality of a short-form video. For instance, the speech-to-video system improves the video output quality by generating enhanced summaries of audio inputs and determines when to identify and incorporate given contexts into a video generation model. Furthermore, depending on the type of short-form video being generated, the speech-to-video system flexibly adjusts which models are used along the video generation pipeline.

Additionally, in various instances, the speech-to-video system uses features of a mobile core network, including network functions located at the edge of the network, to provide functionality to the speech-to-video system. In some instances, the speech-to-video system facilitates different edge components to perform different functions of the speech-to-video system. For example, one or more network function sets implement one or more processing models for quickly and efficiently generating audio summaries, audio contexts, and/or short-form videos. Additionally, when the speech-to-video system implements multiple network function sets, the various edge component sets communicate with each other to quickly and efficiently generate enhanced short-form videos using the various processing models. By leveraging these features and components, the speech-to-video system generates and delivers enhanced short-form videos more efficiently and quickly to user devices than existing systems.

This disclosure uses several terms to describe the features and benefits of one or more implementations. For instance, a “cloud computing system” or “distributed computing system” may be used interchangeably to refer to a network of connected computing devices that provide various services to computing devices (e.g., customer devices). As mentioned above, a cloud computing system can include a collection of physical server devices (e.g., server nodes) organized in a hierarchical structure including clusters, computing zones, virtual local area networks (VLANs), racks, fault domains, etc. In one or more embodiments described in this disclosure, a portion of the cellular network (e.g., a core network) may be implemented in whole or in part on a cloud computing system. In one or more embodiments a data network may be implemented on the same or a different cloud computing network as the portion of the cellular network.

In one or more embodiments, the cloud computing system includes one or more edge networks. As used herein, an “edge network” refers to an extension of the cloud computing system located on the periphery of the cloud computing system. The edge network may be a hierarchy of one or more devices that provide connectivity to devices and/or services on a datacenter within a cloud computing system framework. An edge network may provide several cloud computing services on hardware with associated configurations in force without requiring a client to communicate with internal components of the cloud computing infrastructure. Indeed, edge networks provide virtual access points that enable more direct communication with components of the cloud computing system than another entry point, such as a public entry point, to the cloud computing system. In one or more implementations, one or more components, models, features, and/or functions of the speech-to-video system are implemented on a device of the edge network.

In this document, the term “radio access network” (RAN) refers to a 3GPP-defined RAN or an open RAN (O-RAN) that is implemented within the framework of a cellular network. In one or more embodiments described herein, a RAN is implemented at least partially on the cloud computing system. In one or more implementations, the RAN or multiple RAN components are implemented on an edge network. As used herein, RAN components may refer to any device or functional module of the RAN that provides radio access functionality on a cellular network. RAN components may refer to physical components implemented at a RAN site, such as a base station or set of co-located base stations. RAN components may also refer to virtualized components, such as a service instance deployed on an edge network or datacenter of a cloud computing system. By way of example and not limitation, RAN components may refer to routers, firewalls, antennas, or any device or other functional component (e.g., a virtualized service) that facilitates a connection between an endpoint (e.g., a mobile device or user equipment (UE)) and a core network.

In this document, the term “video generation request” refers to a request directly or indirectly from a user context data (e.g., a mobile device or UE) to generate a short-form video from audio input. A video generation request includes access to audio input. In this document, the term “audio input” refers to a file or stream of audio that includes captured speech (e.g., recognizable words) from at least one user.

In this document, the terms “text summary,” “summary of the audio input,” or simply “summary” refer to a text representation of the speech within the audio input that differs from a text transcript. For example, the summary will be a derivative work of the text transcript that adds additional words to portions of the text transcript, removes words from portions of the text transcript, translates portions of the text transcript, characterizes the transcript, and/or re-writes portions of the text transcript. In some implementations, the text summary also includes additional data and information about the audio input, such as audio context information or metadata.

In this document, the term “audio context” refers to additional information or descriptive data associated with the audio input. In various instances, audio context includes metadata that provides contextual details about the audio content. Audio context metadata can include various attributes such as theme, mood, sentiment, keywords, identified users, identified entities, and other relevant information that provides insights into the audio content.

In this document, the term “short-form video” refers to video content that is relatively brief in duration, typically ranging from a few seconds to a few dozen seconds. In some circumstances, a short-form video is a few minutes in length. In various instances, short-form videos are optimized for consumption on platforms such as social media platforms and mobile apps.

In this document, the term “machine-learning model” refers to a computer model or computer representation that can be trained (e.g., optimized) based on inputs to approximate unknown functions. For instance, a machine-learning model can include, but is not limited to, an autoencoder model, a distortion classification model, a neural network (e.g., a convolutional neural network or deep learning model), a decision tree (e.g., a gradient-boosted decision tree), a linear regression model, a logistic regression model, or a combination of these models (e.g., an image restoration machine-learning model that includes an autoencoder model (autoencoder for short) and a distortion classification model (distortion classification for short)), a generative model system (e.g., a generative language model system (GLM system) such as a Large Language Model (LLM). Examples of machine-learning models in this document include versions of speech-processing models, speech context models, and speech-to-video models.

In this document, the term “neural network” refers to a machine learning model that includes interconnected artificial neurons that communicate and learn to approximate complex functions, generating outputs based on multiple inputs provided to the model. A neural network includes an algorithm (or set of algorithms) that employs deep learning techniques and utilizes training data to adjust the parameters of the network and model high-level abstractions in data. Various types of neural networks exist, such as convolutional neural networks (CNNs), residual learning neural networks, recurrent neural networks (RNNs), generative neural networks, generative adversarial neural networks (GANs), and single-shot detection (SSD) networks.

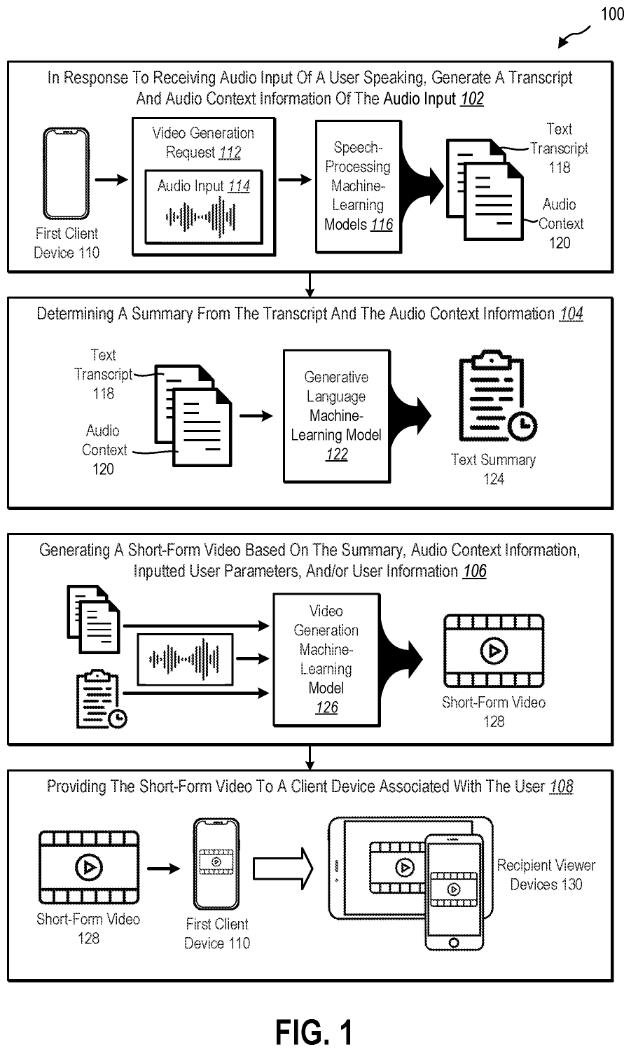

Further details regarding an example implementation of the speech-to-video system are discussed in connection with the following figures. For example, FIG. 1 provides an overview example of implementing a speech-to-video system that automatically generates enhanced short-form videos from audio input of a user's speech according to some implementations. As shown, FIG. 1 includes a series of acts 100 performed by the speech-to-video system. FIG. 1 also shows various elements, features, and components associated with the speech-to-video system, including a first client device 110 and recipient viewer devices 130.

The series of acts 100 in FIG. 1 also includes the act 102 of generating, in response to receiving audio input of a user speaking, a transcript and audio context information of the audio input. For example, the speech-to-video system receives a video generation request 112 from a first client device 110 that includes audio input 114.

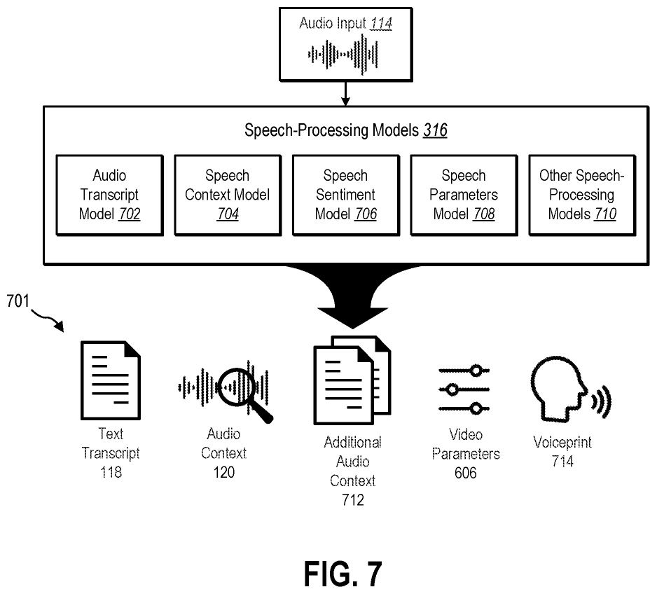

In response, the speech-to-video system utilizes one or more speech-processing machine-learning models 116 to generate a text transcript 118 as well as audio context 120 of the audio input 114. The speech-to-video system may use different models to determine different types of audio context and metadata from the audio input 114. Additional details regarding generating transcripts and audio contexts of audio input using speech-processing machine-learning models are provided in connection with other figures in this document including FIG. 7.

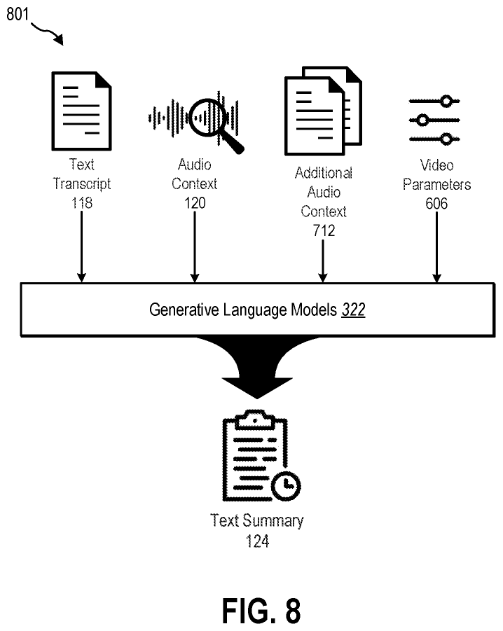

As shown, the series of acts 100 includes an act 104 of determining a summary from the transcript and the audio context information. In various implementations, the speech-to-video system utilizes a generative language machine-learning model 122, such as an LLM to generate a text summary 124 from the text transcript 118 and the audio context 120. As described in this document, the text summary 124 may be a reformulated version of the text transcript 118 that is better suited as an input query of a video generation model and/or include additional context determined from the audio input 114. Additional details regarding generating a text summary are provided in connection with other figures in this document including FIG. 8.

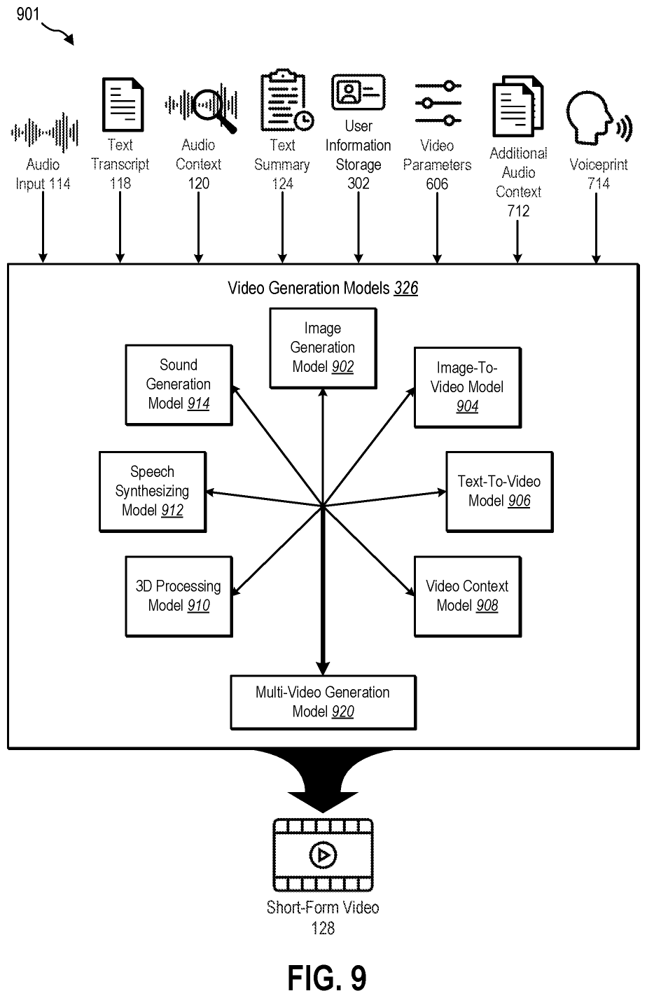

As shown, the series of acts 100 includes an act 106 of generating a short-form video based on the summary, audio context information, inputted user parameters, and/or user information. In various implementations, the speech-to-video system provides the text summary 124, which is based on the audio context 120, to a video generation machine-learning model 126 to generate a short-form video 128. In some instances, the speech-to-video system also provides the audio context 120 along with other inputs, such as additional context information, user information of one or more users, video parameters provided by the user, audio inputs, and/or other inputs, which the video generation machine-learning model 126 utilizes to generate the short-form video 128. Additional details regarding generating short-form videos are provided in connection with other figures in this document including FIG. 9.

FIG. 1 also shows the act 108 of providing the short-form video 128 to a client device associated with a user. In various implementations, the speech-to-video system provides the short-form video 128 back to the first client device 110. In additional implementations, the speech-to-video system allows the user to share the short-form video 128 with recipient viewer devices 130.

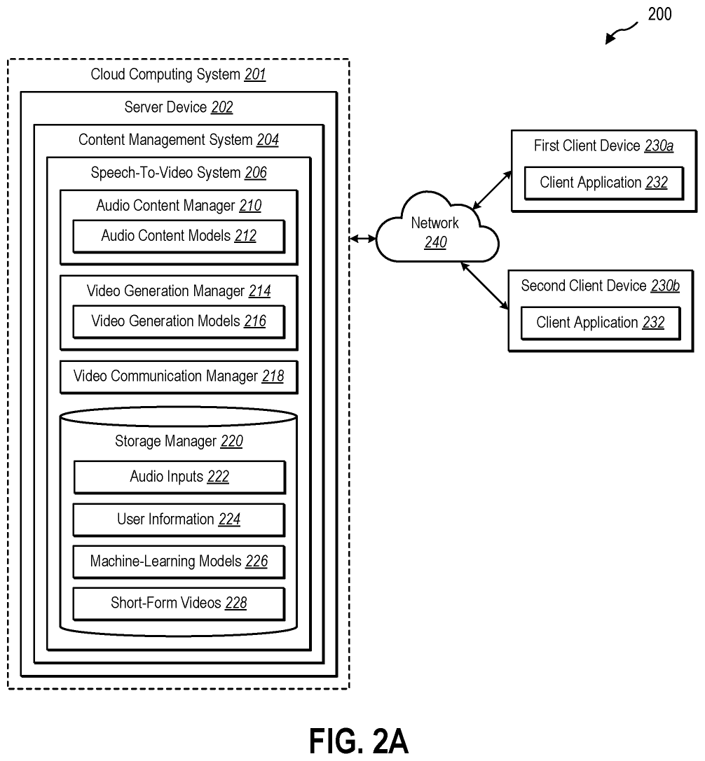

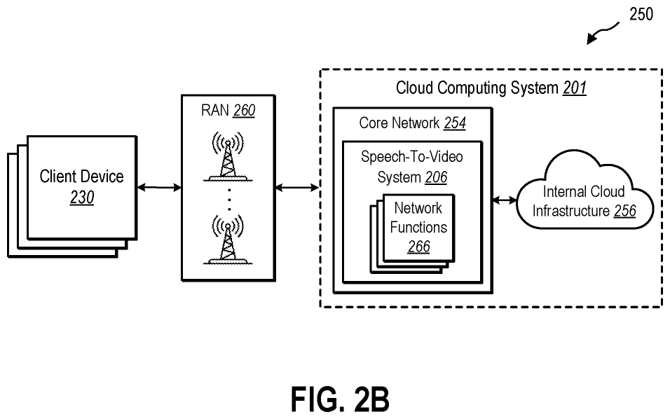

With a general overview of the speech-to-video system in place, additional details are provided regarding the components, features, elements, and environments of the speech-to-video system. To illustrate, FIGS. 2A-2B show example system environments where a speech-to-video system is implemented. For example, FIG. 2A illustrates an example of a computing environment where a speech-to-video system is implemented and FIG. 2B illustrates an example of a core network that implements a speech-to-video system, which may incorporate the computing environment in FIG. 2A. While FIGS. 2A-2B show example arrangements and configurations of the speech-to-video system and associated components, other arrangements and configurations are possible.

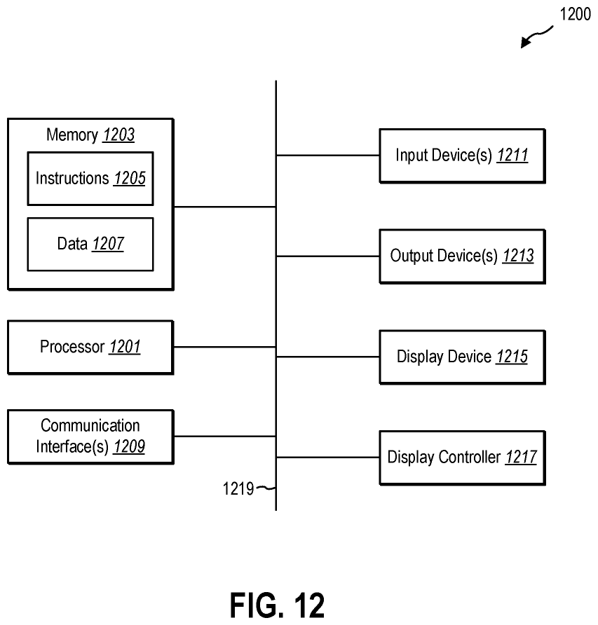

FIG. 2A, as shown, includes a computing environment 200 of a computing system having a cloud computing system 201, a first client device 230a, and a second client device 230b, which are connected by a network 240. Further details regarding these and other computing devices are provided below in connection with FIG. 12. In addition, FIG. 12 also provides additional details regarding networks, such as the network 240 shown.

As shown, the cloud computing system 201 includes a server device 202, which represents one or more server devices. The server device 202 includes a content management system 204. In various implementations, the content management system 204 manages digital content hosted and/or accessed by the server device 202. For example, the content management system 204 manages the communication of digital content, such as audio and/or video files between devices, such as between client devices and/or devices that provide resources and services.

The content management system 204 includes the speech-to-video system 206. In some implementations, the speech-to-video system 206 is located outside of the content management system 204. In various implementations, portions of the content management system 204 are located across different components, such as on different sets of network functions within a mobile core network, within other devices of a cloud computing system, or on a client device.

As mentioned above, the speech-to-video system 206 provides a pipeline for automatically generating enhanced short-form videos from the speech of a user. The pipeline utilizes various models to automatically convert speech from an audio input into an enhanced short-form video. Additionally, the speech-to-video system 206 utilizes different paths and models within the pipeline to generate short-form videos from speech, as further described below.

As shown, the speech-to-video system 206 includes various components and elements, which are implemented in hardware and/or software. For example, the speech-to-video system 206 includes an audio content manager 210 that manages text transcriptions, text summaries, and audio contexts. The audio content manager 210 uses an audio content model 212 (e.g., one of the machine-learning models 226) that extracts text, contexts, and metadata from audio inputs 222. The speech-to-video system 206 also includes a video generation manager 214 that generates short-form videos 228 using video generation models 216 and/or other models of the machine-learning models 226 based on audio inputs 222, user information 224, audio contexts, and/or video parameters.

Additionally, the speech-to-video system 206 includes a video communication manager 218 that manages communications with client devices, such as a client device that requests a short-form video to be made. The video communication manager 218 also implements communications with viewer client devices. The speech-to-video system 206 also includes a storage manager 220 that includes data relevant to the speech-to-video system 206. As shown, the storage manager 220 includes audio inputs 222, user information 224 (e.g., of both sender users and recipient users), machine-learning models 226, and short-form videos 228.

In addition, the computing environment 200 includes a first client device 230a and a second client device 230b each having a client application 232. In some instances, the first client device 230a and the second client device 230b are user equipment (UE) connected to a mobile telecom network (e.g., the cloud computing system 201). In various implementations, the first client device 230a is associated with a first user who provides audio input to the speech-to-video system 206 to be converted into a short-form video. In addition, the second client device 230b is associated with one or more additional users who receive and watch the short-form video provided by the first client device 230a.

As mentioned, each of the client devices includes a client application 232. For example, the client application 232 can be a web browser application, a mobile application, or another type of application that accesses internet-based content for accessing and receiving digital content. In some implementations, a client device includes a plugin associated with the speech-to-video system 206 that communicates with the client application 232 to perform corresponding actions. In some implementations, a portion of the speech-to-video system 206 is integrated into the client device or the client application 232 to perform corresponding actions.

FIG. 2B illustrates an example core network that implements a speech-to-video system. As shown, FIG. 2B includes the communication environment 250, such as a pre-5G cellular network, a 5G cellular network, or another emerging cellular network. For example, the communication environment 250 may include the cloud computing system 201, as described above in connection with FIG. 2A.

As shown, the cloud computing system 201 includes a core network 254 and an internal cloud infrastructure 256 (e.g., a cloud datacenter). The communication environment 250 may additionally include client devices 230 (e.g., the first client device 230a and the second client device 230b) and a RAN 260 (radio access network). In many instances, the components (e.g., a RAN, a core network, and a data network) in the core network 254 collectively form a public or private cellular network, which includes a RAN, a core network, and a data network.

In some implementations, one or more portions of the cellular network are implemented on a cloud computing system that includes the core network 254 and the internal cloud infrastructure 256. In one or more embodiments, components of the core network 254 and/or RAN 260 may be implemented as part of an edge network or other decentralized infrastructure in which computing nodes of the cloud computing system 201 are physically implemented at locations that are in proximity to or otherwise closer to the client devices 230 than other components of the cloud computing system 201 (e.g., the internal cloud infrastructure 256).

In various implementations, the client devices 230 may refer to a variety of computing devices or device endpoints such as a mobile device. Alternatively, one or more of the client devices 230 may refer to non-mobile devices such as a desktop computer, a server device (e.g., an edge network server), or other non-portable devices. In one or more embodiments, the client devices 230 refer more generally to any endpoint capable of communicating with devices on a cloud computing system 201, such as Internet of Things (IoT) devices, or other Internet-enabled devices. In one or more embodiments, the client devices 230 refer to applications or software constructs on corresponding computing devices.

The RAN 260 may include a plurality of RAN sites. In one or more embodiments, each RAN site may include one or more base stations and associated RAN components. While the RAN 260 may include components that are entirely separate from the core network 254, one or more embodiments of the communication environment 250 may include one or more RAN components or services traditionally offered by a RAN site that are implemented on the cloud computing system 201 (e.g., as part of the core network 254). Indeed, as communication networks become more complex and further decentralized, one or more components of the RAN 260 may be implemented as virtualized components hosted by server nodes of the cloud computing system 201, such as on server nodes of an edge network, the core network 254 and/or on datacenters of the internal cloud infrastructure 256 (or across multiple cloud components).

As shown, the internal cloud infrastructure 256 includes the speech-to-video system 206, which may include one or more network functions 266. The one or more network functions 266 may refer to a variety of entities that are configured to access and make use of the hosted storage resource. In one or more cases, the various network functions may refer to not only those functions that are serviced as part of the core network 254 but also one or more virtualized RAN components implemented as a service or otherwise hosted on the cloud computing system 201.

In some cases, the speech-to-video system 206 utilizes one or more network functions 266 to implement various machine-learning models, as mentioned earlier and later. In some implementations, the machine-learning models 226 are placed on edge components to provide quicker access to the client devices 230.

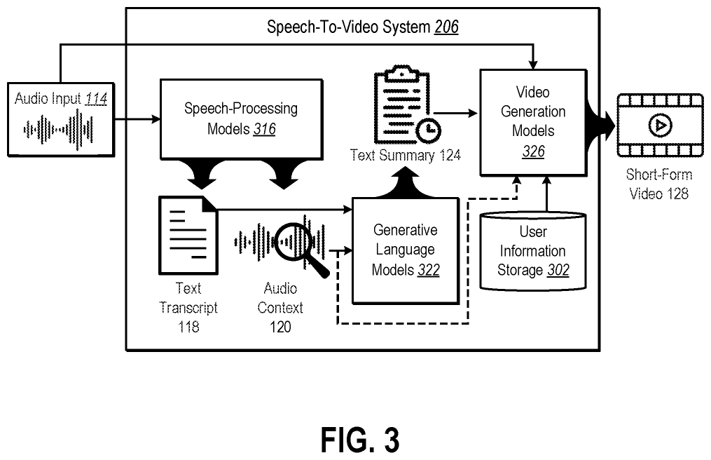

FIG. 3 illustrates a block diagram of an example pipeline for generating a short-form video utilizing the speech-to-video system 206. FIG. 3 includes the speech-to-video system 206, the audio input 114, and the short-form video 128 previously introduced. In addition, the speech-to-video system 206 includes speech-processing models 316, generative language models 322, and video generation models 326 along with user information storage 302. In one or more implementations, the speech-to-video system 206 trains and updates one or more of these models. In some implementations, the speech-to-video system 206 obtains or accesses one or more of the models.

Upon receiving the audio input 114, the speech-to-video system 206 utilizes the speech-processing models 316 to generate the text transcript 118 and the audio context 120. For instance, the speech-processing models 316 include a transcript generation model that converts the audio input 114 into the text transcript 118 and one or more context generation models that detect and determine the audio context 120. In some instances, the speech-to-video system 206 generates additional audio contexts by analyzing the audio input 114. Additional details regarding the generation of transcripts and audio contexts from audio input using speech-processing models are provided in connection with other figures in this document including FIG. 7.

In one or more implementations, the speech-to-video system 206 may determine to repeat a step within the pipeline. For example, based on the audio context 120, the speech-to-video system 206 determines to run the audio input 114 through an additional and/or different speech-processing model. In some instances, the speech-to-video system 206 uses an additional speech-processing model to generate additional audio contexts based on determining one or more attributes present in the audio context 120.

As shown, the speech-to-video system 206 utilizes the generative language models 322 to generate a text summary 124 for the audio input 114 from the text transcript 118 and the audio context 120. For example, the speech-to-video system 206 utilizes one or more LLMs to generate the text summary 124. In various implementations, the speech-to-video system 206 provides a formulated query to the generative language models 322, which provides instructions on how to generate the text summary 124 from the text transcript 118 in a way that is better suited as input for the video generation models 326.

By generating the text summary 124, the speech-to-video system 206 adds context and clarity to the audio input 114, improving the input to the video generation models 326 and thus enhancing the resulting short-form video. In some instances, the speech-to-video system 206 generates a summary that includes contextual information related to the text transcript 118. For example, the text summary 124 indicates the tone, mood, and sentiment of the audio input 114. It may also include information about the speaker/sender/requestor and/or the target audience. For instance, the text summary 124 indicates when a message or phrase was delivered with sarcasm conveyed seriously. The text summary 124 may incorporate the emotion of a message.

In various implementations, the text summary 124 clarifies the text transcript 118 by editing, rephrasing, paraphrasing, and/or reorganizing the text. For example, the speech-to-video system 206 uses the generative language models 322 to remove pause or filler words, eliminate redundant information, and shorten, condense, or decrease lengthy explanations to increase clarity, improve grammar, and better match the tone of the message. For instance, the speech-to-video system 206 shortens a message to fit within the shorter time constraints of a short-form video (e.g., the text summary 124 includes a message that can be spoken within a 15-second video).

In various implementations, the speech-to-video system 206 expands the text summary 124 by adding additional information to improve the clarity of a message and/or to improve the efficiency of the video generation models 326. In some implementations, the speech-to-video system 206 adds characteristics and attributes of the audio input 114 to the text summary 124. For instance, the generative language models 322 add one or more sentences to set up the context of the audio input 114 (e.g., the text summary 124 starts with a paragraph or list that provides parameters of a requested video).

In some implementations, the speech-to-video system 206 modifies the text of the transcript to explicitly incorporate a contextual attribute in the text summary 124. For example, the speech-to-video system 206 changes the phrase “I will see you tonight” from the text transcript 118 to “I am very excited to see you tonight” in the text summary 124 when the phrase was spoken with enjoyment. In various implementations, the speech-to-video system 206 re-writes the text transcript 118 into a narrative, dialogue, script, screenplay, or story that serves as a better input for the video generation models 326 than the text transcript 118 itself. In some instances, the speech-to-video system 206 uses additional textual cues to indicate the context of a phrase, such as when a phrase was spoken loudly, softly, quickly, slowly, etc.

In various instances, the text summary 124 also includes cues indicating additional context information. For example, the text summary 124 includes keywords, locations, people, entities, environments, opinions, or other data. The text summary 124 may specify video parameters (e.g., length, theme, artistic styles), audio settings (use of a specific voice, sound effect, or background music), or promotional resources (e.g., the user is authorized to apply a particular voice, background video, voice, or background song).

In some implementations, the speech-to-video system 206 translates the text transcript 118 to another language for various reasons. For example, the speech-to-video system 206 may translate the transcript to align with the input parameters of a particular version of the video generation models 326. In some cases, the requesting user wants to reach viewing users who speak a different language. For instance, the text summary 124 includes multiple translations of a message to be spoken or written in different versions of a short-form video.

As mentioned above, the speech-to-video system 206 may repeat a step of the pipeline and/or determine to use multiple versions of a model. For example, the speech-to-video system 206 generates a first version of a text summary using a first generative language model. The speech-to-video system 206 then uses the same generative language model again or another generative language model to generate an updated version of the text summary.

As shown, the speech-to-video system 206 utilizes the video generation models 326 to generate the short-form video 128 using various inputs, including the audio input 114, the text summary 124, the audio context 120, and information from the user information storage 302. The video generation models may use fewer or additional inputs. Additionally, some inputs may be incorporated or included in the text summary 124, such as the audio context 120 and/or user information from the user information storage 302. In certain instances, a video generation model may use both the text summary 124 and the audio input 114 or only the text summary 124 to generate a short-form video.

In some instances, the speech-to-video system 206 determines which version of the video generation models 326 to use based on information from the text summary 124. For example, inputs are routed to a specific video generation model based on indications in the text summary 124 regarding the requested video type, style, the target audience, and/or video parameters. In some instances, depending on time constraints and/or service quality agreements, the speech-to-video system 206 determines to use a lightweight video generation model instead of a more robust model that may take longer to generate a video.

As mentioned above, the speech-to-video system 206 utilizes the video generation models 326 to generate the short-form video 128. For example, one or more video generation models utilize the inputs from the text summary 124 to directly or indirectly generate a short-form video representing the audio input 114. Additional details regarding generating short-form videos are provided in connection with other figures in this document including FIG. 9.

The user information storage 302, as shown in FIG. 3, provides an input to the video generation models 326. In various implementations, the user information storage 302 offers user information related to the requesting user. For instance, the user information storage 302 provides demographic information such as age, preferences, previously shared content, and other pieces of relevant data. In some cases, user information includes images and/or videos of the user. Additionally, user information may include a voiceprint of the user, allowing a video generation model to recreate or modify the user's voice within the short-form video.

Similarly, in some instances, the user information storage 302 provides general and/or specific user information about one or more target audience users. For example, if the message is intended for a particular group or target audience, the speech-to-video system 206 uses the user information storage 302 to provide characteristics and attributes about the target audience to the video generation models 326. The speech-to-video system 206 may also supply a voiceprint, image, or video of a target audience user to the video generation models 326.

In some implementations, the speech-to-video system 206 provides user information from the user information storage 302 to the generative language models 322 and/or the speech-processing models 316. For example, the generative language models 322 utilize characteristics or attributes about the requesting user to add additional context to the text summary 124.

Additionally, in various implementations, the speech-to-video system 206 determines when to perform different actions required for generating short-form videos. For example, depending on the capabilities and/or processing availability of the first client device 230a, the speech-to-video system 206 decides whether to run a model locally, within one or more network functions of a mobile core network, or within a computing device of a cloud computing system.

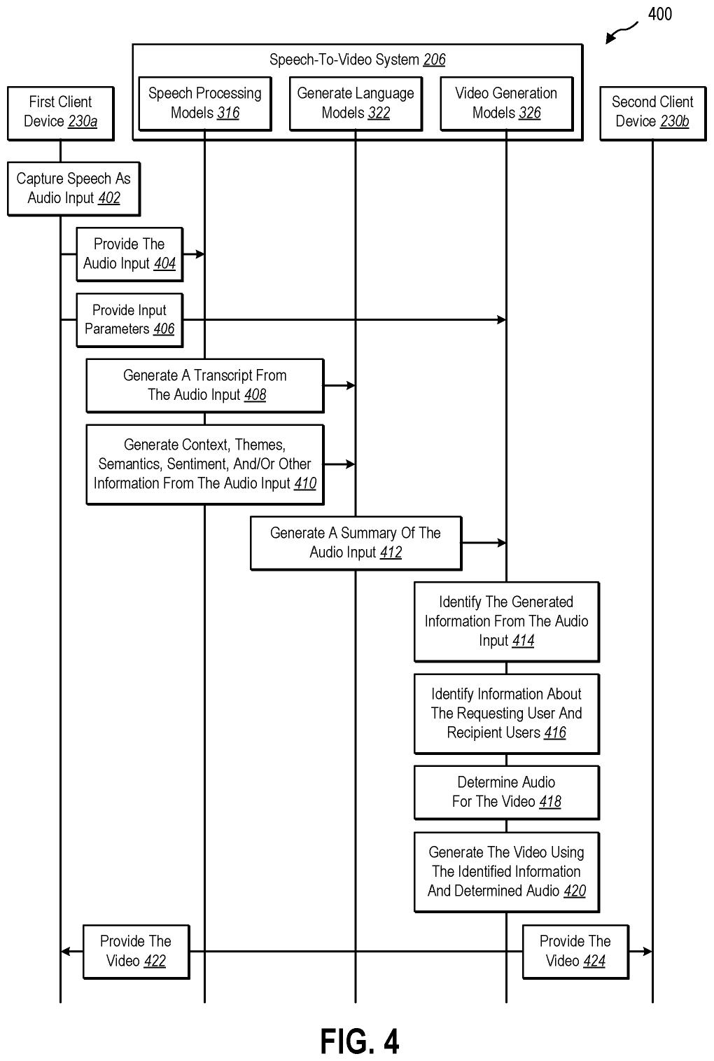

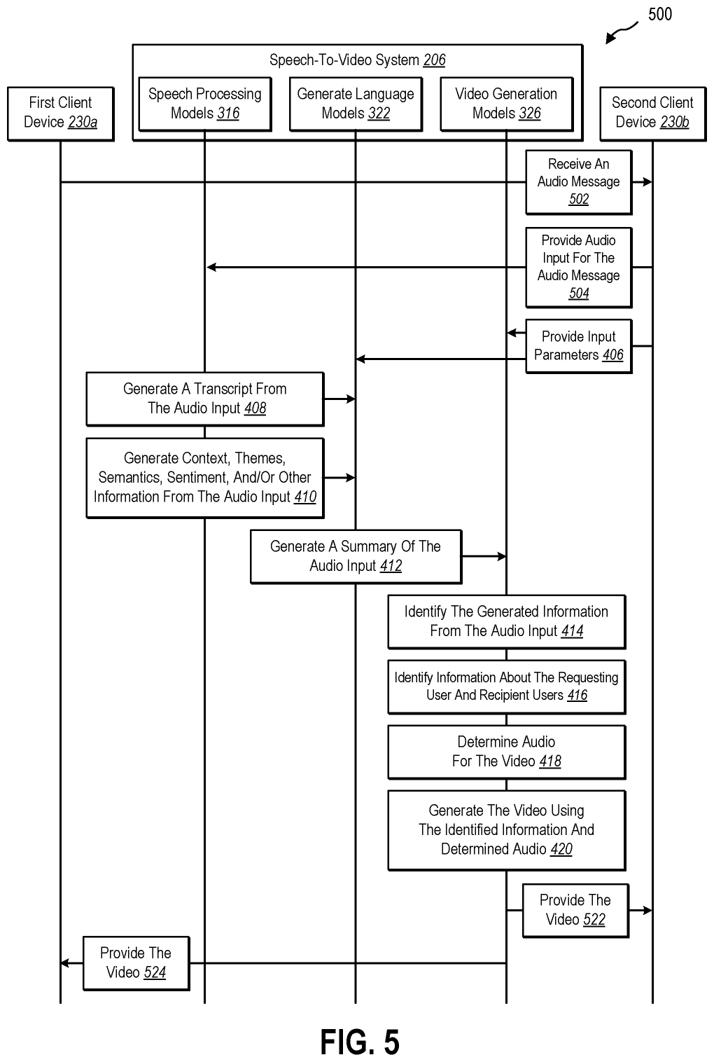

Turning to the next set of figures, FIG. 4 and FIG. 5 provide example use cases of the speech-to-video system 206 generating and providing short-form videos from audio input. As shown, FIG. 4 and FIG. 5 each include the speech-to-video system 206, the first client device 230a, and the second client device 230b introduced above. Additionally, the speech-to-video system 206 includes the speech-processing models 316, the generative language models 322, and the video generation models 326.

FIG. 4 illustrates a sequence flow diagram of the speech-to-video system generating a short-form video for a first user device to send to other user devices. In particular, FIG. 4 includes a series of acts 400 for generating short-form videos. In many instances, the speech-to-video system 206 performs the series of acts 400.

As shown, the series of acts 400 includes the act 402 of capturing speech as audio input. For example, a microphone on the first client device 230a captures and provides a recording or a stream of audio input to the speech-to-video system 206. In some implementations, the audio input is provided via a graphical user interface and/or client application to request a short-form video from audio. In connection with capturing speech as audio input, the first client device 230a provides the audio input to the speech-to-video system 206, as shown in the act 404.

In various implementations, the first client device 230a also provides input parameters to the speech-to-video system 206, as shown in the act 406. In some implementations, the input parameters include a set of default video input parameters. In various implementations, the input parameters include one or more video input parameters selected by a user. For example, the speech-to-video system 206 provides a user with an interactive interface that allows a user to modify various parameters and provide preferences for a short-form video. The first client device 230a utilizes these input parameters at various stages in generating the short-form video. For example, as shown, the input parameters are provided to the generative language models 322 and the video generation models 326.

As shown, the series of acts 400 includes the act 408 of generating a transcript from the audio input. For instance, the speech-to-video system 206 utilizes one or more of the speech-processing models 316 to generate a text transcript of the audio input. In various implementations, the transcript includes information about the audio input, such as timestamps, pauses, and when different speakers are talking. In some instances, the speech-to-video system 206 allows a user to edit the transcript for accuracy.

The series of acts 400 also includes the act 410 of generating context, themes, semantics, sentiment, and/or other information from the audio input. For instance, the speech-processing models 316 generate various forms of audio context and metadata, as described elsewhere in this document.

As shown in the act 412, the speech-to-video system 206 generates a summary of the audio input. The speech-to-video system 206 utilizes one or more models from the generative language models 322 to generate a text summary from the information generated from the audio input, such as the text transcript and the audio context. As mentioned, the speech-to-video system 206 may use an LLM to craft a summary of the audio input that includes a fuller context beyond a mere text transcription. In various implementations, the video generation models 326 also utilize user information to generate the summary.

Upon generating a summary, the speech-to-video system 206 proceeds to generate the short-form video using one or more of the video generation models 326. To illustrate, the series of acts 400 includes an act 414 of identifying the generated information from the audio input. For example, the speech-to-video system 206 gathers the summary, audio context information, user inputs, and/or other relevant information to generate the requested short-form video.

Similarly, the series of acts 400 includes the act 416 of identifying information about the requesting user and recipient users. For instance, the speech-to-video system 206 obtains user information from a database or user information memory store for the requesting user and/or recipient users in the target audience. The speech-to-video system 206 then provides this user information to the video generation models 326 for use in generating the short-form video.

Additionally, the series of acts 400 includes the act 418 of determining the audio for the video. The audio for the short-form video includes one or more voices speaking during the video, background music, sound effects, and other audio used in the short-form video. For example, the speech-to-video system 206 determines whether to use the user's voice in the short-form video. If so, the speech-to-video system 206 then determines whether to use portions of the audio input and/or synthesize the user's voice. In some implementations, the speech-to-video system 206 decides to use another voice in the short-form video, such as a character voice, a voice of another user, or a synthetic voice. For example, the user may purchase a voice pack of different voices to use within a short-form video.

In some implementations, the speech-to-video system 206 determines whether to include music and/or sound effects in the short-form video. For example, if the user desires a particular theme or song, the speech-to-video system 206 provides this information to the video generation models 326. Similarly, the speech-to-video system 206 may instruct the video generation models 326 to add one or more sound effects and/or allow the video generation models 326 to make this decision as part of generating the short-form video.

As shown, the series of acts 400 includes the act 420 of generating the video using the identified information and determined audio. For example, the speech-to-video system 206 provides various inputs to the video generation models 326, which generates the short-form video. The level of detail provided to the speech-processing models 316 may vary depending on the complexity and decision-making capabilities of the video generation models 326. Additional details regarding the generation of short-form videos using the video generation models 326 are provided in other figures in this document including FIG. 9.

FIG. 4 also includes the act 422 of providing the video to the first client device 230a and the act 424 of providing the video to the second client device 230b. For example, in various implementations, the speech-to-video system 206 sends the short-form video to the requesting user for viewing. In response, the user may approve the video, request a new video be generated without additional input, or request an updated video be generated with additional input and/or feedback.

In some implementations, the speech-to-video system 206 facilities sharing the short-form video with one or more recipient users (e.g., the second client device 230b). In some implementations, the speech-to-video system 206 provides the video directly or indirectly (e.g., via a content-sharing platform) to the second client device 230b.

In various implementations, the speech-to-video system 206 performs many of these acts without user intervention. For example, the first client device 230a sends a request to the speech-to-video system 206 that includes audio input. In response, the speech-to-video system 206 provides the short-form video to the first client device 230a and/or the second client device 230b. When the speech-to-video system 206 is located, at least in part, within network functions at the edge of a mobile core network, the speech-to-video system 206 can provide the short-form video to the first client device 230a in real-time or near-real-time.

FIG. 5 illustrates a sequence flow diagram of the speech-to-video system generating a short-form video for a user device that receives audio input from another user device. FIG. 5 includes a series of acts 500 for generating a short-form video. As shown, the series of acts 500 includes and/or repeats many of the actions described above as part of the series of acts 400.

While the series of acts 400 corresponds to a first use case where a requesting user generates and provides audio input to the speech-to-video system 206 for generating a short-form video, the series of acts 500 corresponds to a second use case where the audio is generated by another user other than the requesting user. For example, in response to receiving a voicemail message or recording from another user, a user requests that the speech-to-video system 206 generates a short-form video. As another example, a user requests that the speech-to-video system 206 generate a short-form video from an audio clip of a song, speech, or other audio recording.

As shown, the series of acts 500 includes the act 502 of receiving an audio message. For example, the first client device 230a creates a message that includes audio input and provides it to the second client device 230b. As mentioned, the audio input can be a voicemail message, speech message, or audio recording and includes recorded speech.

In response, the second client device 230b provides the audio input from the audio message to the speech-to-video system 206, as shown in the act 504. For instance, the speech-to-video system 206 is part of a client application that identifies audio input on the second client device 230b and initiates the process of generating a short-form video from it. In some implementations, a user using the second client device 230b requests that the speech-to-video system 206 generate a short-form video from the audio input provided by the user, which was provided by another user using the first client device 230a.

Additionally, as shown in the act 406, the second client device 230b provides input parameters to the speech-to-video system 206. In various implementations, the series of acts 500 skips the act 406 and/or utilizes default input parameters. In some implementations, the user using the second client device 230b provides one or more video input parameters to the speech-to-video system 206, such as video length, style, or theme.

As shown, the series of acts 500 repeats the acts 408-420. In particular, the speech-to-video system 206 generates a transcript from the audio input (the act 408) and generates context, themes, semantics, sentiment, and/or other information from the audio input (the act 410) using the speech-processing models 316. Additionally, the speech-to-video system 206 utilizes the generative language models 322 to generate a summary of the audio input (the act 412).

Furthermore, the speech-to-video system 206 identifies the generating information of the audio input (the act 414), identifies information of the requesting user and recipient user (the act 416), and/or determines the audio for the video (the act 418), as mentioned earlier. The speech-to-video system 206 also utilizes the video generation models 326 to generate the video using the identified information and determined audio (the act 420).

As shown, the series of acts 500 includes the act 522 of providing the video to the second client device 230b. For example, the speech-to-video system 206 provides the generated short-form video to the second client device 230b upon generating the video from the audio input. In response, the second client device 230b may view the video, request a new or modified version of the video from the speech-to-video system 206, delete the video, and/or share the video. For example, the act 524 shows the speech-to-video system 206 providing the short-form video to the first client device 230a, which can occur directly or indirectly.

In some implementations, the speech-to-video system 206 performs the series of acts 500 automatically. For example, the second client device 230b includes a default setting to automatically convert voicemails into short-form videos from specific recipients (or all voicemails). As another example, the speech-to-video system 206 automatically detects segments of audio input and generates short-form videos for the second client device 230b.

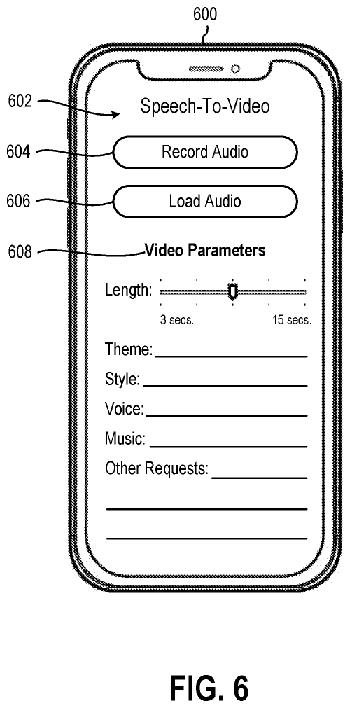

FIG. 6 illustrates an example graphical user interface for a user to request the generation of a short-form video. As mentioned, the speech-to-video system 206 allows a user to select and adjust video parameters for generating short-form videos. In various implementations, the speech-to-video system 206 provides an interactive interface to the user for this purpose. While FIG. 6 shows one example of an interactive interface, the speech-to-video system 206 may provide various types of interactive interfaces to allow users to specify their video parameter preferences.

As shown, FIG. 6 includes a mobile device 600. The mobile device 600 represents a computing device, such as a client device and/or a UE. As shown, the mobile device 600 includes a graphical user interface 602, which serves as an interactive interface provided by the speech-to-video system 206 for selecting video input parameters.

The graphical user interface 602 includes elements for receiving input audio. For instance, the record audio element 604 causes the mobile device 600 to capture and provide audio input as a recording or stream. The video parameters 606 allow the user to select audio input from a local or remote source.

The graphical user interface also includes a video parameter section 608 where the speech-to-video system 206 enables the user to specify video parameter preferences. For example, the speech-to-video system 206 allows the user to select, modify, and/or specify different video parameters such as video length, theme, style, music, and other requests. The speech-to-video system 206 may present these video parameters as various types of interactive elements, such as sliders, text fields, dropdown menus, multiple-choice options, radio buttons, or links. Based on the selections made in the video parameter section 608, the speech-to-video system 206 can determine the optimal pipeline path to generate the requested short-form video.

In some implementations, the speech-to-video system 206 also allows the user to specify video parameters within the audio input itself, either in addition to or instead of specifying them through the graphical user interface. For example, as part of the audio input, the user may speak one or more video preferences, such as the desired length of the short-form video, theme, voice type, emotion, or environment. In these implementations, the speech-to-video system 206 detects and extracts the user's video parameter preferences from the audio input. In some cases, the user provides verbal video parameters in a separate instance of audio input. In various implementations, the user verbally can modify their default video parameter preferences by indicating so in the audio input.

As mentioned above, FIG. 7 provides additional details regarding the generation of transcripts and audio contexts of audio input using speech-processing machine-learning models. In particular, FIG. 7 illustrates an example block diagram of speech-processing models. As shown, FIG. 7 includes the audio input 114, the speech-processing models 316, and various generated outputs 701. The speech-processing models 316 may include various types of speech-processing-based machine-learning models, as further described below.

As shown, the speech-processing models 316 include an audio transcript model 702, which generates a text transcript 118 of the audio input 114 and a speech context model 704 that analyzes the audio input 114 to extract and/or determine audio context 120. In some implementations, the speech context model 704 includes multiple models that generate different types of audio context (shown as additional audio context 712). For example, the speech context model 704 determines themes, keywords, entities, people, places, times, vocabulary levels, languages, and other context information. In various implementations, the speech context model 704 provides confidence scores for contexts discovered from the audio input 114.

Additionally, the speech-processing models 316 include a speech sentiment model 706. For instance, the speech sentiment model 706 analyzes the audio input 114 to determine sentiments, opinions, attitudes, moods, emotions, changes in volume, feelings, pace, and other sentiment information. The speech sentiment model 706 may also generate the additional audio context 712 shown.

The speech-processing models 316 also include a speech parameters model 708. As shown, the speech parameters model 708 detects when a user specifies video parameters 606 within the audio input 114. For example, the speech parameters model 708 detects specified requests corresponding to themes, video lengths, target audiences, voices, sound effects, video effects, background music, video style, or other video parameters. Additionally, the speech-processing models 316 include other speech-processing models 710. For example, the other speech-processing models 710 include a voice identify detection model that determines a voiceprint 714 of a user speaking. The other speech-processing models 710 may also include a language service model and/or a cognitive service model that generates additional contexts for the audio input 114.

As mentioned above, FIG. 8 provides additional details regarding the generation of a text summary using generative language models. In particular, FIG. 8 illustrates an example block diagram of generative language models. As shown, FIG. 8 includes model inputs 801, the generative language models 322, and the text summary 124.

As shown, the speech-to-video system 206 provides the model inputs 801 to the generative language models 322 in order to generate the text summary 124. In various implementations, the model inputs 801 include one or more of the various generated outputs 701 from the speech-processing models 316. As shown, the model inputs 801 include the text transcript 118, the audio context 120, the additional audio context 712, and the video parameters 606. The speech-to-video system 206 may provide additional or fewer inputs to the generative language models 322 (e.g., user information).

As mentioned, the generative language models 322 generate the text summary 124. In many instances, the text summary 124 adds context to the text transcript 118, often using a human-readable narrative. In some implementations, the generative language models 322 rewrite, rephrase, and/or expand the text transcript 118 to improve clarity and/or make it more suitable as input to the video generation models 326 (e.g., changing the writing style to address a different audience).

In various instances, the generative language models 322 enhance clarity by removing or reducing content from the text transcript 118 based on the audio context 120, additional audio context 712, and/or the video parameters 606. For example, if the video parameters 606 specify a longer short-form video, the generative language models 322 expand or include more content in the text summary 124 to enable the video generation models 326 to more efficiently generate the longer video (and vice versa).

As mentioned above, FIG. 9 provides additional details regarding the generation of short-form videos using video generation models. In particular, FIG. 9 illustrates an example block diagram of speech-to-video models. As shown, FIG. 9 includes model inputs 901, the video generation models 326, and the short-form video 128.

FIG. 9 shows that the video generation models 326 include various models used to generate some or all of the short-form video 128. In many instances, one of the video generation models 326 utilizes one or more of the model inputs 901 to generate portions of short-form videos. In various implementations, the speech-to-video system 206 utilizes a combination of video generation models 326 and/or uses the same model for multiple iterations to generate the short-form video 128. While some video generation models are shown, the speech-to-video system 206 may use additional or different video models to generate the short-form video 128.

As shown, the video generation models 326 include an image generation model 902. In various implementations, the image generation model 902 generates one or more images from the model inputs 901, such as the text summary 124 and the audio context 120 (which may be incorporated into the text summary 124). For example, the image generation model 902 utilizes text inputs to generate a sequence of images.

As shown, the video generation models 326 include an image-to-video model 904. In some implementations, the image-to-video model 904 generates video from one or more images. For example, the image generation model 902 provides its output images to the image-to-video model 904. Additionally, in various instances, the image-to-video model 904 also utilizes the model inputs 901 to generate a video. For instance, the image-to-video model 904 utilizes the text summary 124, the audio context 120, and the video parameters 606. In some instances, the image-to-video model 904 utilizes additional or different inputs from the model inputs 901.

As shown, the video generation models 326 include a text-to-video model 906. In one or more implementations, the text-to-video model 906 uses text input from the text summary 124 to generate the short-form video 128. As with the other models, the text-to-video model 906 may also utilize additional inputs from the model inputs 901, such as the audio context 120, the additional audio context 712, the text transcript 118, and/or the video parameters 606. In some instances, the model inputs 901 may provide additional context to the text-to-video model 906 to generate a video that more accurately reflects the desires of the requesting user.

As shown, the video generation models 326 include a video context model 908. In various implementations, the video context model 908 adds contexts, such as themes, sentiments, styles, keywords, entities, products, and other contexts, to a video generated by one of the other models. The text-to-video model 906 may also consider user information from the user information storage 302 when generating a video. In some implementations, the video context model 908 directly generates a video that focuses on the context from the text summary 124, the audio context 120, and/or the additional audio context 712. In one or more implementations, the video context model 908 is part of another video generation model.

As shown, the video generation models 326 include a 3D processing model 910. In some implementations, the short-form video is an animated video and/or includes three-dimensional (3D) animations. Accordingly, the video generation models 326 include the 3D processing model 910, which generates 3D characters, objects, scenes, and/or other 3D content. In many instances, the 3D processing model 910 generates the 3D content based on one or more of the model inputs 901. In some implementations, the 3D processing model 910 generates 3D content requested by another model of the video generation models 326.

As shown, the video generation models 326 include a speech synthesizing model 912. In various implementations, the speech synthesizing model 912 generates synthetic voices for the short-form video 128. For instance, based on the voiceprint 714 of the requesting user or a recipient user, the speech synthesizing model 912 generates synthetic speech to add to a video. In some instances, the speech synthesizing model 912 generates synthetic speech using a synthesized voice or another user's voice accessible to the requesting user (e.g., a purchased character voice). Additionally, in some implementations, the speech synthesizing model 912 determines to add portions or snippets of the audio input 114 into a short-form video.

As shown, the video generation models 326 include a sound generation model 914. In various implementations, the sound generation model 914 generates and/or incorporates music, noises, sound effects, and other sounds into a video. The sound generation model 914 may determine which sounds to generate and/or add based on various inputs from the model inputs 901. In various instances, the sound generation model 914 works with or is part of another one of the video generation models 326 to add an audio track to the short-form video 128.

As shown, the video generation models 326 include a multi-video generation model 920. In various implementations, the multi-video generation model 920 is a jointly-trained machine-learning model or neural network that learns to perform multiple functions of the video generation models 326 described above. For example, the multi-video generation model 920 generates short-form videos by creating context-based videos and corresponding audio. The multi-video generation model 920 utilizes one, more, or all of the model inputs 901 as well as additional or different inputs to generate the short-form video 128.

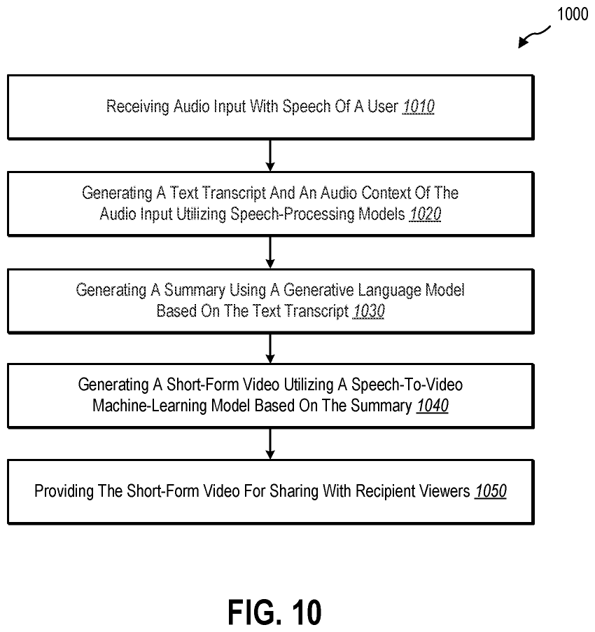

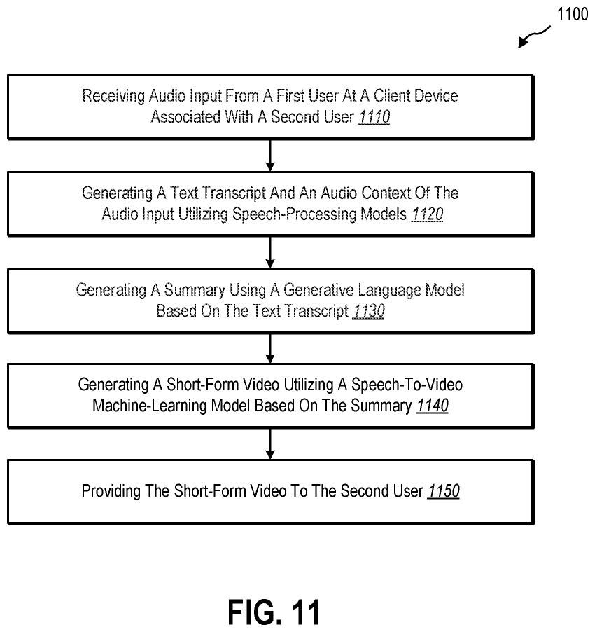

Turning now to FIG. 10 and FIG. 11, each of these figures illustrates an example flowchart that includes a series of acts for utilizing the speech-to-video system 206 according to one or more implementations. In particular, FIG. 10 and FIG. 11 each illustrates an example series of acts of computer-implemented methods for generating short-form video content from audio input.

While FIG. 10 and FIG. 11 each illustrates acts according to one or more implementations, alternative implementations may omit, add, reorder, and/or modify any of the acts shown. Further, the acts of FIG. 10 and FIG. 11 can each be performed as part of a method such as a computer-implemented method. Alternatively, a non-transitory computer-readable medium can include instructions that, when executed by a processor, cause a computing device to perform the acts of FIG. 10 and FIG. 11. In some implementations, a system can perform (e.g., a processing system with a processor can cause instructions to perform a series of operations) the acts of FIG. 10 and FIG. 11.

As shown in FIG. 10, the series of acts 1000 includes an act 1010 of receiving audio input with speech of a user. For example, the act 1010 involves receiving a video generation request that includes audio input of a first user speaking. In various implementations, the act 1010 includes determining parameters for the short-form video based on portions of the speech extracted from the audio input. In some implementations, the act 1010 includes providing a graphical user interface (used for requesting the short-form video) to the client device associated with the first user, which prompts for the audio input and one or more parameters of the short-form video. In some instances, the graphical user interface includes a video length input parameter, a video theme input parameter, and/or an audio input parameter.

As further shown, the series of acts 1000 includes an act 1020 of generating a text transcript and an audio context of the audio input utilizing speech-processing models. For instance, in example implementations, the act 1020 involves determining a text transcript and an audio context of the audio input utilizing one or more speech-processing machine-learning models.

In some implementations of the act 1020, the one or more speech-processing machine-learning models utilize user profile information (e.g., of the first user or another user) to generate additional information to include in the audio context. In additional implementations, the video generation machine-learning model is located on a first set of network functions at an edge of a mobile core network (e.g., a 5G network) that generates short-form videos in real time. In some implementations, the generative language machine-learning model is located on a second set of network functions at the edge of the mobile core network. In various implementations, the first set of network functions communicates with the second set of network functions.

In one or more implementations of the act 1020, the one or more speech-processing machine-learning models generate the audio context by determining a theme, sentiment, or mood of the audio input. In some implementations, determining the text summary includes translating the text transcript to another language, expanding the text transcript to include additional context based on the first user, and reducing or decreasing a length of the text transcript (e.g., to match or align with the video length of the short-form video).

As further shown, the series of acts 1000 includes an act 1030 of generating a summary using a generative language model based on the text transcript. For instance, in example implementations, the act 1030 involves generating a text summary using a generative language machine-learning model based on the text transcript of the audio input and the audio context. In various implementations, the generative language machine-learning model generates the text summary by re-writing or rephrasing the text transcript to optimize it as an input for the video generation machine-learning model.

As further shown, the series of acts 1000 includes an act 1040 of generating a short-form video utilizing a video generation machine-learning model based on the summary. For instance, in example implementations, the act 1040 involves generating a short-form video utilizing a video generation machine-learning model based on the text summary and the audio context. In various implementations of the act 1040, the video generation machine-learning model generates the short-form video further based on user profile information of the first user or parameters of the short-form video provided by the first user. In some implementations, the parameters of the short-form video include a video length input parameter, a video theme input parameter, and/or a video style input parameter.

In one or more implementations of the act 1040, the video generation machine-learning model generates a set of corresponding images based on the text summary and the audio context, generates an audio track based on the text summary and the audio context, and/or generates the short-form video using the set of corresponding images and the audio track. In some instances, the video generation machine-learning model generates the short-form video by combining generated video images with portions or segments of speech from the first user extracted from the audio input.

In various implementations of the act 1040, the video generation machine-learning model generates the short-form video by combining generated video images with a synthesized voice of the first user. In some implementations, the video generation machine-learning model generates one or more three-dimensional objects within the short-form video. Additionally, in some implementations, the video generation machine-learning model generates the short-form video to match a predefined or predetermined time limit.

As further shown, the series of acts 1000 includes an act 1050 of providing the short-form video for sharing with recipient viewers. For instance, in example implementations, the act 1050 involves providing the short-form video to a client device associated with the first user for sharing the short-form video with one or more recipient viewers.

Turning to FIG. 11, as shown, the series of acts 1100 includes an act 1110 of receiving audio input from a first user at a client device associated with a second user. For example, the act 1110 involves receiving audio input with speech from the first user at a client device associated with a second user. In some implementations, the act 1110 includes generating the short-form video of the audio input from the first user without receiving input from the second user. In various implementations, the speech in the audio input is of the first user corresponding to the audio input.

As further shown, the series of acts 1100 includes an act 1120 of generating a text transcript and an audio context of the audio input utilizing speech-processing models. For instance, in example implementations, the act 1120 involves determining a text transcript of the audio input and an audio context utilizing one or more speech-processing machine-learning models.

As further shown, the series of acts 1100 includes an act 1130 of generating a summary using a generative language model based on the text transcript. For instance, in example implementations, the act 1130 involves generating a text summary using a generative language machine-learning model based on the text transcript and the audio context of the audio input.

As further shown, the series of acts 1100 includes an act 1140 of generating a short-form video utilizing a video generation machine-learning model based on the summary. For instance, in example implementations, the act 1140 involves generating a short-form video utilizing a video generation machine-learning model based on the text summary and the audio context. In various implementations of the act 1140, the video generation machine-learning model generates the short-form video further using a first user profile of the first user and a second user profile of the second user. In some instances, the video generation machine-learning model generates the short-form video further using a voiceprint of the first user to create synthetic speech of the first user.

As further shown, the series of acts 1100 includes an act 1150 of providing the short-form video to the second user. For instance, in example implementations, the act 1150 involves providing the short-form video to the client device associated with the second user for viewing the short-form video on the client device.

FIG. 12 illustrates certain components that may be included within a computer system 1200. The computer system 1200 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1200 represents one or more of the client devices, server devices, or other computing devices described above. For example, the computer system 1200 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1200 includes a processing system including a processor 1201. The processor 1201 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1201 may be referred to as a central processing unit (CPU) and may cause computer-implemented instructions to be performed. Although the processor 1201 shown is just a single processor in the computer system 1200 of FIG. 12, in an alternative configuration, a combination of processors (e.g., an ARM and DSP) could be used.

The computer system 1200 also includes memory 1203 in electronic communication with the processor 1201. The memory 1203 may be any electronic component capable of storing electronic information. For example, the memory 1203 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1205 and the data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during the execution of the instructions 1205 by the processor 1201.

A computer system 1200 may also include one or more communication interface(s) 1209 for communicating with other electronic devices. The one or more communication interface(s) 1209 may be based on wired communication technology, wireless communication technology, or both. Some examples of the one or more communication interface(s) 1209 include a Universal Serial Bus (USB), an Ethernet adapter, a wireless adapter that operates according to an Institute of Electrical and Electronics Engineers (IEEE) 1202.11 wireless communication protocol, a Bluetooth® wireless communication adapter, and an infrared (IR) communication port.

A computer system 1200 may also include one or more input device(s) 1211 and one or more output device(s) 1213. Some examples of the one or more input device(s) 1211 include a keyboard, mouse, microphone, remote control device, button, joystick, trackball, touchpad, and light pen. Some examples of the one or more output device(s) 1213 include a speaker and a printer. A specific type of output device that is typically included in a computer system 1200 is a display device 1215. The display device 1215 used with implementations disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For clarity, the various buses are illustrated in FIG. 12 as a bus system 1219.

This disclosure describes a speech-to-video system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating short-form video content from audio, the computer-implemented method comprising:
receiving a video generation request that includes audio input of a first user speaking;
determining a text transcript and an audio context of the audio input utilizing one or more speech-processing machine-learning models;
generating a text summary using a generative language machine-learning model based on the text transcript of the audio input and the audio context;
generating a short-form video utilizing a video generation machine-learning model based on the text summary and the audio context; and
providing the short-form video to a client device associated with the first user for sharing the short-form video with one or more recipient viewers.

2. The computer-implemented method of claim 1, wherein the video generation machine-learning model is located on a first set of network functions at an edge of a mobile core network that generates short-form videos in real time.

3. The computer-implemented method of claim 2, wherein the generative language machine-learning model is located on a second set of network functions at the edge of the mobile core network.

4. The computer-implemented method of claim 1, wherein the one or more speech-processing machine-learning models generate the audio context by determining a theme, sentiment, or mood of the audio input.

5. The computer-implemented method of claim 1, wherein determining the text summary includes translating the text transcript to another language, expanding the text transcript to include additional context based on the first user, and decreasing a length of the text transcript.

6. The computer-implemented method of claim 1, wherein the generative language machine-learning model generates the text summary by re-writing the text transcript to optimize it as an input for the video generation machine-learning model.

7. The computer-implemented method of claim 1, wherein the video generation machine-learning model generates the short-form video further based on user profile information of the first user or parameters of the short-form video provided by the first user.

8. The computer-implemented method of claim 7, wherein the parameters of the short-form video include a video length input parameter, a video theme input parameter, and a video style input parameter.

9. The computer-implemented method of claim 1, wherein the video generation machine-learning model:
generates a set of corresponding images based on the text summary and the audio context;
generates an audio track based on the text summary and the audio context; and
generates the short-form video using the set of corresponding images and the audio track.

10. The computer-implemented method of claim 1, wherein the video generation machine-learning model generates the short-form video by combining generated video images with portions of speech from the first user extracted from the audio input.

11. The computer-implemented method of claim 1, wherein the video generation machine-learning model generates the short-form video by combining generated video images with a synthesized voice of the first user.

12. The computer-implemented method of claim 1, wherein the video generation machine-learning model generates one or more three-dimensional objects within the short-form video.

13. A system for generating short-form video content from audio, the system comprising:
a processor; and
memory including instructions that, when executed by the processor, cause the system to carry out operations comprising:
receiving a video generation request that includes audio input of a first user speaking;
determining a text transcript of the audio input and an audio context utilizing one or more speech-processing machine-learning models;
generating a text summary using a generative language machine-learning model based on the text transcript and the audio context of the audio input;
generating a short-form video utilizing a video generation machine-learning model based on the text summary and the audio context; and
providing the short-form video to a client device associated with the first user for sharing the short-form video with one or more recipient viewers.

14. The system of claim 13, further comprising determining parameters for the short-form video based on portions of speech extracted from the audio input.

15. The system of claim 13, wherein the operations further include providing a graphical user interface for requesting the short-form video to the client device associated with the first user that prompts for the audio input and one or more parameters of the short-form video, wherein the graphical user interface includes a video length input parameter, a video theme input parameter, and an audio input parameter.

16. The system of claim 13, wherein the one or more speech-processing machine-learning models utilize user profile information to generate additional information to include in the audio context.

17. A computer-implemented method for generating short-form video content from audio, the computer-implemented method comprising:
receiving audio input with speech from a first user at a client device associated with a second user;
determining a text transcript of the audio input and an audio context utilizing one or more speech-processing machine-learning models;
generating a text summary using a generative language machine-learning model based on the text transcript and the audio context of the audio input;
generating a short-form video utilizing a video generation machine-learning model based on the text summary and the audio context; and
providing the short-form video to the client device associated with the second user for viewing the short-form video on the client device.

18. The computer-implemented method of claim 17, further comprising generating the short-form video of the audio input from the first user without receiving input from the second user.

19. The computer-implemented method of claim 17, wherein the video generation machine-learning model generates the short-form video further using a first user profile of the first user and a second user profile of the second user.

20. The computer-implemented method of claim 19, wherein the video generation machine-learning model generates the short-form video further using a voiceprint of the first user to create synthetic speech of the first user.
